(19) United States
(12) Patent Application Publication
(10) Pub. No.: US 2007/0085251 A1
(43) Pub. Date: Apr. 19, 2007

(54) Vibration absorbing alloy member, and rubber vibration isolator, floor vibration damping apparatus, tires, steel cord and rubber sesmic isolator using the same

(75) Inventors: Masami Kikuchi, Tokyo (JP); Takashi Yokoi, Tokyo (JP); Takahisa Shizuku, Tokyo (JP); Satoshi Aizawa, Tokyo (JP); Kazutomo Murakami, Tokyo (JP); Hiroyuki Ueda, Tokyo (JP); Shigenobu Suzuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 10/573,346

(22) PCT Filed: Sep. 24, 2004
(86) PCT No.: PCT/JP04/13957

§ 371 Date: Mar. 24, 2006

(30) Foreign Application Priority Data
Sep. 24, 2003 (JP) 2003-331570
Dec. 2, 2003 (JP) 2003-402802
Jan. 21, 2004 (JP) 2004-012817
Mar. 4, 2004 (JP) 2004-060874

(51) Int. Cl. F16F 3/08

(52) U.S. Cl. 267/152

(57) ABSTRACT

A damping alloy member 1 is constructed in such a manner that the improvement consists of a twin crystal type damping alloy made of Cu—Al—Mn alloy, Mg—Zr alloy, Mn—Cu alloy, Mn—Cu—Ni—Fe alloy, Cu—Al—Ni alloy, Ti—Ni alloy, Al—Zn alloy, Cu—Zn—Al alloy, Mg alloy, Cu—Si alloy, Fe—Mn—Si alloy, Fe—Ni—Co—Ti alloy, Fe—Ni—C alloy, Fe—Cr—Ni—Mn—Si—Co alloy and Ni—Al alloy, and has a shape of a flake, a wire or a spring for optimizing a deformation of the alloy. Moreover, a rubber vibration isolator, a floor vibration damping apparatus, a tire, a steel cord and a quake-absorbing rubber are constructed by using the damping apply member.

### TECHNICAL FIELD

The present invention relates to a damping alloy member having a function of reducing a vibration and a noise during driving and moving, and a rubber vibration isolator, a floor vibration damping apparatus, a tire, a steel cord and a quake-absorbing rubber using the same.

### BACKGROUND ART

Heretofore, in order to reduce a vibration and a noise during driving and moving, a damping member is used in various technical fields. As one example, in the case that a vibration generated by an operation of a machine 201 is not transferred to a basement 202 as shown in FIG. 17a, or, in the case that a vibration generated at the basement 202 is not transferred to the machine as shown in FIG. 17b, a rubber vibration isolator 203 is arranged between the machine 201 and the basement 202 (Web site of BRIDGESTONE CORPORATION/theory of rubber vibration isolator [searched on Sep. 17, 2003], internet, URL://www.bridgestone-dp.jp/dp/ip/do/bousin/dg/dg 2.html.) The reason for using the rubber vibration isolator 203 such applications is that components have a simple and compact structure and one component can be used as a spring for three directions and that a vibration at a resonance state is small as compared with a metal spring.

The damping member having the structure mentioned above has, up to now, a function for reducing a vibration and a noise sufficiently. However, recently a requirement for developing the damping member having further high performance is increased. Moreover, in a rubber vibration isolator, a floor vibration damping apparatus, a tire, a steel cord and so on, a requirement for further reducing a vibration and a noise is increased.

In addition, a quake-absorbing equipment for an architecture a bridge construction is known, which is used for improving a safety of a construction member such as a road bridge by absorbing an energy at an earthquake occurring. As one example, as shown in FIG. 18, a quake-absorbing rubber system is known, in which a quake-absorbing equipment 263 is arranged between a road 261 and a road bridge 262 for supporting the road 261 and in which an energy of an earthquake is absorbed by deforming in a horizontal direction (Web site of BRIDGESTONE CORPORATION/high damping quake-absorbing rubber support (HDR) [searched on Oct. 8, 2003], internet URL://www.bridgestone-dp.jp/dp/ip/road/shishozai/shishozai07.html). Normally, the quake-absorbing equipment 263 mentioned above has a construction such that a laminated rubber 266 having an integral structure in which a high damping rubber sheet 264 and a metal plate 265 are alternately laminated is used as a main member as shown in FIG. 19.

The laminated rubber 266 having the structure mentioned above has three elements such as a load supporting performance, a resilience (spring) and a damping force, which are required for the quake-absorbing equipment 263. However, recently, a requirement for developing a quake-absorbing rubber having a further damping force.

### DISCLOSURE OF INVENTION

An object of the invention is to eliminate the drawbacks mentioned above and to provide a damping alloy member having a function for reducing a high vibration and a noise, and a rubber vibration isolator, a floor vibration damping apparatus, a tire and a steel cord using the same, and to further provide a quake-absorbing rubber which can cease a continuous vibration by means of a high damping efficiency and which can achieve a high damping performance as compared with a known quake-absorbing rubber.

According to the invention, a damping alloy member is characterized in that the improvement consists of a twin crystal type damping alloy made of Cu—Al—Mn alloy, Mg—Zr alloy, Mn—Cu alloy, Mn—Cu—Ni—Fe alloy, Cu—Al—Ni alloy, Ti—Ni alloy, Al—Zn alloy, Cu—Zn—Al alloy, Mg alloy, Cu—Si alloy, Fe—Mn—Si alloy, Fe—Ni—Co—Ti alloy, Fe—Ni—C alloy, Fe—Cr—Ni—Mn—Si—Co alloy and Ni—Al alloy, and has a shape of a flake, a wire or a spring for optimizing a deformation of the alloy.

Moreover, according to a preferred example using the damping alloy member of the invention, a floor vibration damping apparatus is characterized in that the improvement consists of a composite material in which a rubber and the damping alloy member mentioned above are compounded. Further, according to a further preferred example, the damping alloy member has a spring structure such that a plurality of springs, having different spring constants in a height direction, are combined and used in such a manner that: a vibration under a low loading state is absorbed by a spring having a low spring constant; and a vibration under a high loading state is absorbed by a spring having a high spring constant, while the spring having a low spring constant is contacted to a cap.

Moreover, according to a preferred example using the damping alloy member of the invention, a tire is characterized in that the damping alloy member mentioned above is embedded in the tire so as to reduce an impact applied to a moving tire from a road surface and to decrease a vibration and a noise. Further, according to a further preferred example, the damping alloy member having a flake shape is used.

Moreover, according to a preferred example using the damping alloy member of the invention, a steel cord is characterized in that the improvement has a structure such that the damping alloy member mentioned above is inserted into an inner portion and an outer portion of the steel cord. Further, according to a further preferred example, the damping alloy member having a wire shape or a crimped wire shape is used, so that a deformation of the steel cord is easily transferred to the damping alloy member, and, a tire consisting of the steel cord mentioned above, is characterized in that, in the case such that the steel cord is deformed by an impact applied to a moving tire from a road surface, the improvement has a function such that a vibration and a noise are reduced by the damping alloy member.

Moreover, according to a preferred example using the damping alloy member of the invention, a first aspect of a quake-absorbing rubber is characterized in that a damper member, in which a rubber and a damper made of the damping alloy member mentioned above are compounded, is combined with a laminated rubber having an integral structure obtained by laminating alternately a high damping rubber sheet and a metal plate.

Moreover, according to a preferred example using the damping alloy member of the invention, a second aspect of a quake-absorbing rubber is characterized in that a damper having a spring shape made of the damping alloy member mentioned above is wound around an outer portion of a laminated rubber having an integral structure obtained by laminating alternately a high damping rubber sheet and a metal plate, and, the laminated rubber and the damper are combined with each other.

Further, according to a preferred example of the first aspect of the quake-absorbing rubber mentioned above, the damper member is arranged at a center portion of the laminated rubber; the damper has a flake shape; and the damper is mixed in the high damping rubber sheet of the laminated rubber. Furthermore, according to a preferred example of the second aspect of the quake-absorbing rubber mentioned above, a periphery of the damper having a spring shape is covered with an elastic member.

### BRIEF DESCRIPTION OF DRAWINGS

FIGS. 1a-1f are schematic views respectively explaining one example of a damping alloy member according to the invention.

FIGS. 2a and 2b are schematic views respectively showing one embodiment of a rubber vibration isolator using the damping alloy member according to the invention.

FIGS. 3a and 3b are schematic views respectively explaining one example of a main portion of the rubber vibration isolator using the damping alloy member according to the invention.

FIGS. 4a and 4b are schematic views respectively explaining another example of a main portion of the rubber vibration isolator using the damping alloy member according to the invention.

FIG. 5 is a schematic view explaining still another example of a main portion of the rubber vibration isolator using the damping alloy member according to the invention.

FIG. 6 is a schematic view explaining still another example of a main portion of the rubber vibration isolator using the damping alloy member according to the invention.

FIG. 7 is a schematic view explaining one example of a vibration damping member of the floor vibration damping apparatus using the damping alloy member according to the invention.

FIG. 8 is a schematic view explaining another example of the vibration damping member of the floor vibration damping apparatus using the damping alloy member according to the invention.

FIGS. 9a and 9b are schematic views respectively explaining one example in which the floor vibration damping apparatus is constructed by using the vibration damping members shown in FIGS. 7 and 8.

FIG. 10 is a schematic view explaining one example of a tire using the damping alloy member according to the invention.

FIGS. 11a-11c are schematic views respectively explaining one example of a steel cord using the damping alloy member according to the invention.

FIG. 12 is a schematic view showing one embodiment of a first aspect of a quake-absorbing rubber using the damping alloy member according to the invention.

FIGS. 13a and 13b are schematic views respectively explaining one example of a damper member of the first aspect of the quake-absorbing rubber using the damping alloy member according to the invention.

FIGS. 14a and 14b are schematic views respectively explaining one example of a damper member of the first aspect of the quake-absorbing rubber using the damping alloy member according to the invention.

FIG. 15 is a schematic showing another embodiment of the first aspect of the quake-absorbing rubber using the damping alloy member according to the invention.

FIG. 16 is a schematic view showing one embodiment of a second aspect of the quake-absorbing rubber using the damping alloy member according to the invention.

FIGS. 17a and 17b are schematic views respectively explaining a theory of the rubber vibration isolator.

FIG. 18 is a schematic view explaining a theory of the quake-absorbing rubber.

FIG. 19 is a schematic view showing one embodiment of a laminated rubber according to a known example.

### BEST MODE FOR CARRYING OUT THE INVENTION

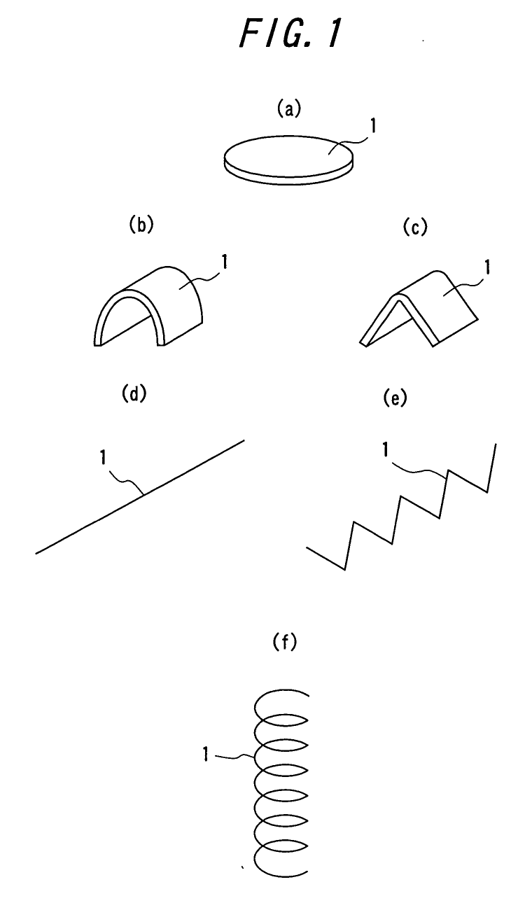

FIGS. 1a-1f are schematic views respectively explaining one example of a damping alloy member according to the invention. In the damping alloy member according to the invention, in order to reduce a vibration and a noise from a viewpoint of shapes, the shapes of a damping alloy member 1 are: a simple flake shape as shown in FIG. 1a; a flake shape having a U-shaped longitudinal cross section as shown in FIG. 1b; a flake shape having a V-shaped longitudinal cross section as shown in FIG. 1c; a linear wire shape as shown in FIG. 1d; a crimped wire shape as shown in FIG. 1e; and a spring shape as shown in FIG. 1f. Moreover, as the damping alloy of a twin crystal type, use is made of Cu—Al—Mn alloy, Mg—Zr alloy, Mn—Cu alloy, Mn—Cu—Ni—Fe alloy, Cu—Al—Ni alloy, Ti—Ni alloy, Al—Zn alloy, Cu—Zn—Al alloy, Mg alloy, Cu—Si alloy, Fe—Mn—Si alloy, Fe—Ni—Co—Ti alloy, Fe—Ni—C alloy, Fe—Cr—Ni—Mn—Si—Co alloy or Ni—Al alloy.

In the damping alloy member 1 having the shape and material mentioned above, it is possible to reduce the vibration and the noise from a viewpoint of shapes in addition to a damping property of the alloy, so that the damping alloy member having a function of reducing a high vibration and noise can be obtained and also a rubber vibration isolator, a floor vibration damping apparatus, a tire and a steel cord, using the damping alloy member can be obtained. Hereinafter, the rubber vibration isolator, the floor vibration damping apparatus, the tire and the steel cord, which use the damping alloy member 1, will be explained in this order.

<As to the Rubber Vibration Isolator>

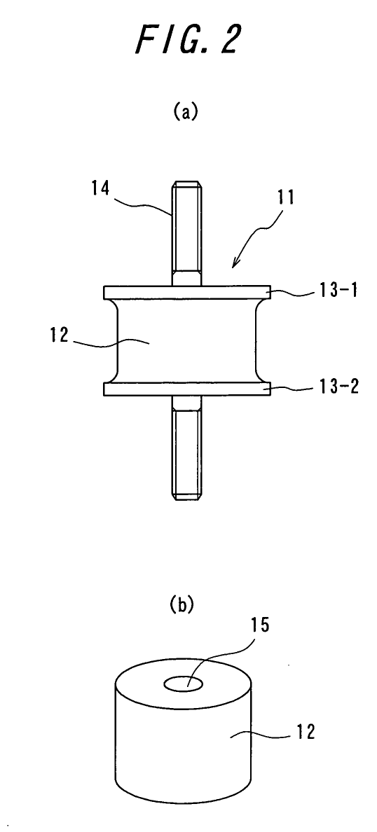

FIGS. 2a and 2b are schematic views respectively showing one embodiment of a rubber vibration isolator using the damping alloy member according to the invention. In the example shown in FIG. 2a, a rubber vibration isolator 11 has a construction such that a main member 12 of the rubber vibration isolator is fixed by: plate members 13-1 and 13-2, which are made of a metal and arranged at both ends thereof; and a shaft member 14, which are made of a metal and penetrated through a center portion thereof. Therefore, as shown in FIG. 2b, a through hole 15 for passing the shaft member 14 is arranged at a center portion of the main member 12 of the rubber vibration isolator. In the case such that the rubber vibration isolator 11 having the construction mentioned above is assembled actually to a machine and so on, it is preferably arranged in such a manner that moving directions due to a vibration and so on are a direction along the shaft member 14 and a direction along planes of the plate members 13-1, 13-2 perpendicular to the direction along the shaft member 14.

A feature of the rubber vibration isolator 11 mentioned above lies on the improvement of the main member 12 of the rubber vibration isolator is constructed by compounding a damper made of the damping alloy member 1 mentioned above with a normal rubber. Hereinafter, the rubber vibration isolator 11 using the damping alloy member 1 according to the invention will be explained in detail.

In the rubber vibration isolator 11 using the damping alloy member 1 according to the invention, the damping alloy member 1 is used as the damper included in the main member 12 of the rubber vibration isolator. As the rubber vibration isolator 11, it is preferred to use Cu—Al—Mn alloy, Mg—Zr alloy, Mn—Cu alloy, Mn—Cu—Ni—Fe alloy, Cu—Al—Ni alloy, Ti—Ni alloy, Al—Zn alloy, Cu—Zn—Al alloy, or Mg alloy, and it is most preferred to use Cu—Al—Mn alloy. In this case, the reason for using the damping alloy of a twin crystal type is as follows. That is to say, a martensite twin crystal structure according to this embodiment is easily deformed by an external input, and, at that time, an energy loss due to hysteresis is generated. This is because the martensite twin crystal is not broken by fatigue, since it is not a material, in which a dislocation is not generated by a plastic deformation, and only a positional relation of atoms are changed. Moreover, among them, the reason for preferably using the alloy of Cy series is that it is firmly connected to S existing in a rubber by a curing reaction.

Moreover, in the rubber vibration isolator 11 using the damping alloy member 1 according to the invention, as a shape of the damper included in the main member 12 of the rubber vibration isolator, it is preferred to use a flake shape, a wire shape, or a spring shape, since a shape of the damping alloy can be optimized. Here, the reason for preferably using these shapes is that a damping effect of the damper can be easily obtained.

Further, in the rubber vibration isolator 11 using the damping alloy member 1 according to the invention, as a material of rubber consisting of a main construction member of the main member 12 of the rubber vibration isolator, it is possible to use any rubber used for the conventional rubber vibration isolators. Specifically, as one example, it is preferred to use a natural rubber, a styrene rubber, a nitrile rubber, a chloroprene rubber and a butyl rubber.

Furthermore, in the rubber vibration isolator 11 using the damping alloy member 1 according to the invention, a compounding rate between the damper and the rubber is not particularly limited. The compounding rate can be determined suitably so as to obtain most suitable damping properties as the rubber vibration 1 having the main member 12 in which the damper and the rubber are compounded. Normally, it is preferred to set the compounding rate such as damper: 1-50 vol % and rubber: remainder. Here, if an amount of the damper is less than 1 vol %, a contribution rate of the alloy is small. On the other hand, if an amount of the damper exceeds 50 vol %, a mixing resistance during the manufacturing becomes too large and thus the manufacturing is not to be possible.

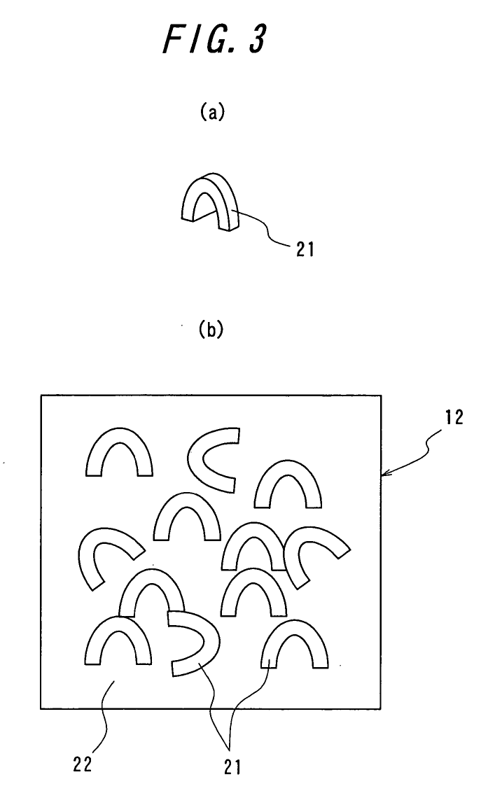

FIGS. 3a and 3b are schematic views respectively explaining one example of a main portion of the rubber vibration isolator using the damping alloy member according to the invention. In this example, use is made of a damper 21 made of the twin crystal type damping alloy member 1 and having a flake shape with a U-shaped longitudinal cross section as shown in FIG. 3a. A plurality of dampers 21 are randomly mixed and compounded in a rubber 22, so that the main member 12 of the rubber vibration isolator is constructed as shown in FIG. 3b. In this example, since, in addition to a damping performance based on an elastic deformation of the rubber 22, a damping performance based on a deformation of twin crystal of the damper 21 made of the damping alloy of twin crystal type, it is possible to obtain a high damping performance as compared with the rubber vibration isolator made of the conventional rubber only.

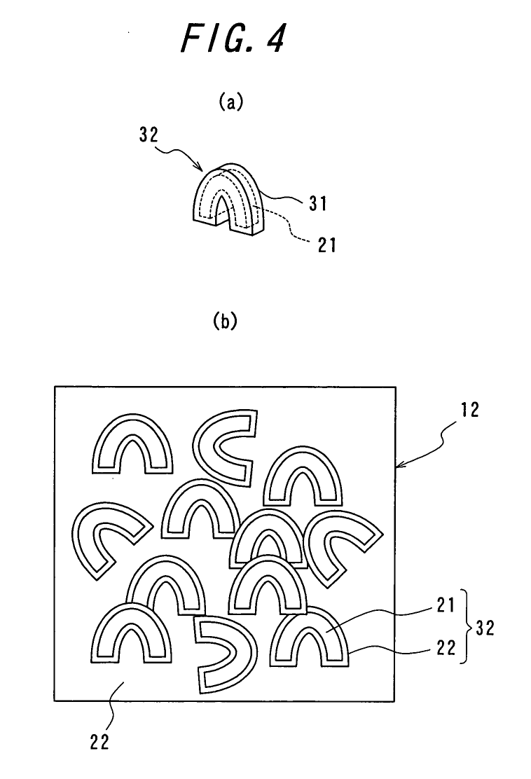

FIGS. 4a and 4b are schematic views respectively explaining another example of a main portion of the rubber vibration isolator using the damping alloy member according to the invention. In this example, use is made of a damper 32 having a structure such that an intermediate layer 31 made of a material having an intermediate deformation stress (Young's modulus, strength) between a damping property of the damper 21 and a damping property of the rubber 22 is arranged to an overall outer surface of the damper 21 made of the twin crystal type damping alloy member 1 having a flake shape with a U-shaped longitudinal cross section as shown in FIG. 3a. As a material having an intermediate damping property between a damping property of the damper 21 and a damping property of the rubber 22, consisting of the intermediate layer 31, use is made of polyamide, polyacetal, polycarbonate, polyphenylene ether, polybutadiene terephthalate, polyphenylene sulfide, amorphous polymer and so on. A plurality of dampers 32 are randomly mixed and compounded in the rubber 22, so that the main member 22 of the rubber vibration isolator is constructed as shown in FIG. 4b. In this example, since, in addition to an effect of obtaining a high damping performance based on the main member 22 of the rubber vibration isolator shown in FIGS. 3a and 3b, the intermediate layer 31 carries out a function as a gradient material, it is possible to obtain a higher damping performance as that of the example shown in FIGS. 3a and 3b.

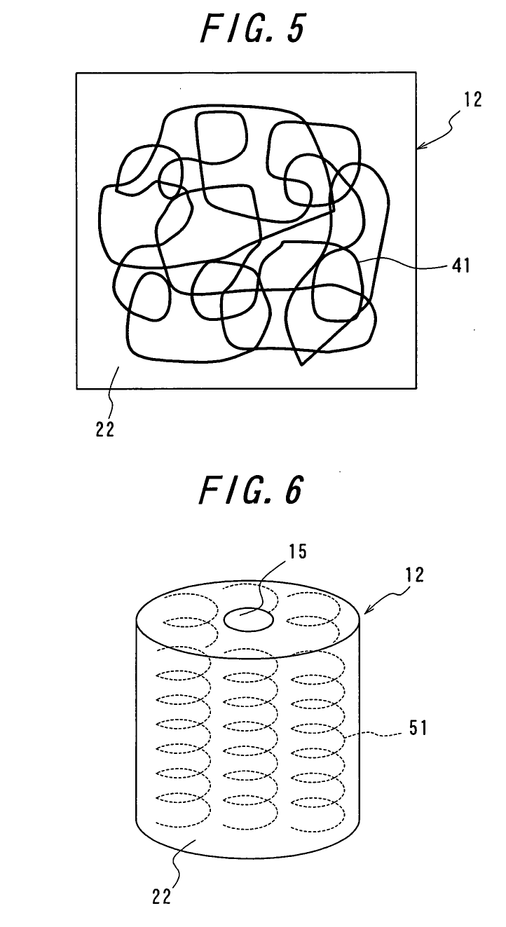

FIG. 5 is a schematic view explaining still another example of a main portion of the rubber vibration isolator using the damping alloy member according to the invention. In this example, use is made of a damper 41 having a structure such that a wire made of the twin crystal type damping alloy member 1 is entangled. The damper 41 is mixed and compounded in the rubber 22, so that the main member 12 of the rubber absorbing isolator is constructed as shown in FIG. 5. Also in this example, it is possible to obtain the same high damping performance as that based on the main member 12 of the rubber absorbing isolator shown in FIGS. 3a and 3b.

FIG. 6 is a schematic view explaining still another example of a main portion of the rubber vibration isolator using the damping alloy member according to the invention. In this example, use is made of a spring made of the twin crystal type damping alloy member 1 as a damper 51. A plurality of dampers 51 are mixed and compounded in the rubber 22 in such a manner that they are aligned in the same direction with each other (in FIG. 6, a direction along the through hole 15), so that the main member 12 of the rubber absorbing isolator is constructed as shown in FIG. 6. In this example, since, in addition to an effect of a high damping performance based on the main member 22 of the rubber vibration isolator shown in FIGS. 3a and 3b, a most elastically deformed direction of the damper 51 (here, a direction penetrated through a winding wire of the spring consisting of the damper 51) is made to be same as a deformation direction of the rubber vibration isolator 11 (here, a direction along the through hole 15), it is possible to obtain a further high damping performance.

<As to the Floor Vibration Damping Apparatus>

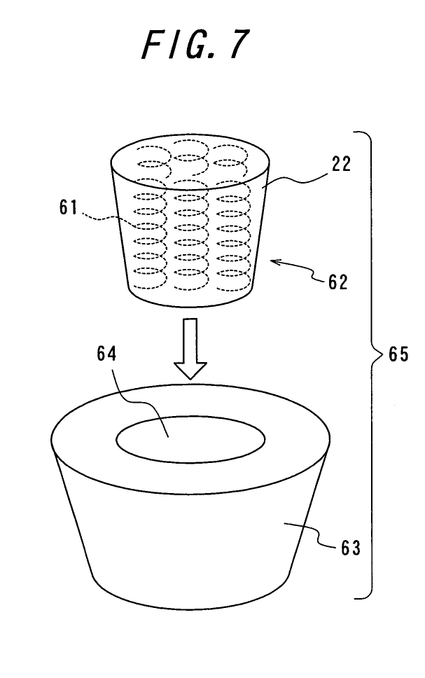

FIG. 7 is a schematic view explaining one example of a vibration damping member of the floor vibration damping apparatus using the damping alloy member according to the invention. In the example shown in FIG. 7, a compound member 62, in which a plurality of springs 61 made of the damping alloy member 1 of the twin crystal type are mixed and compounded in the rubber 22 in such a manner that they are aligned in the same direction, is inserted into a through hole 64 of a rubber main member 63 so as to form an integral body, so that a vibration damping member 65 is obtained.

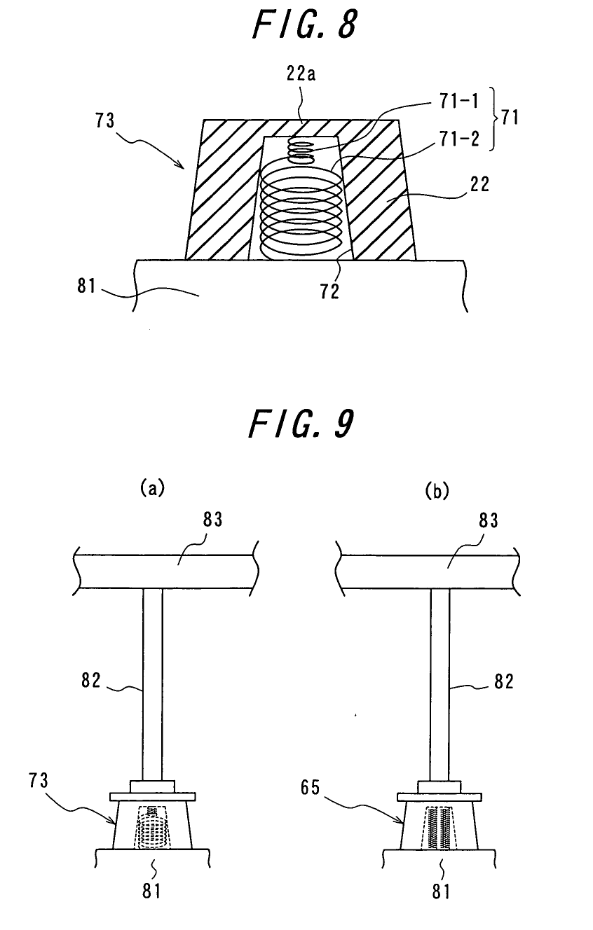

FIG. 8 is a schematic view explaining another example of the vibration damping member of the floor vibration damping apparatus using the damping alloy member according to the invention. In the example shown in FIG. 8, a spring 71 made of the damping alloy member 1 of the twin crystal type is arranged in a hollow portion 72 of the rubber 22, so that a vibration damping member 73 is obtained. In this case, the spring 71 has a spring structure such that a plurality of springs, i.e. here two springs 71-1 and 71-2 having different spring constants in a height direction, are combined and used in such a manner that: a vibration under a low loading state is absorbed by the spring 71-1 having a low spring constant; and a vibration under a high loading state is absorbed by the spring 71-2 having a high spring constant, while the spring 71-1 having a low spring constant is contacted to a cap 22a.

FIGS. 9a and 9b are schematic views respectively explaining one example in which the floor vibration damping apparatus is constructed by using the vibration damping members 65 and 73 respectively shown in FIGS. 7 and 8. As shown in FIGS. 9a and 9b, a floor member 83 is supported with respect to a base member 81 by means of the vibration damping members 65 and 73 and a column member 82, so that the floor vibration damping apparatus is obtained. In this example, it is possible to reduce a vibration and a noise on the floor member 83 by means of the floor vibration damping apparatus using the damping alloy member 1 according to the invention.

<As to the Tire>

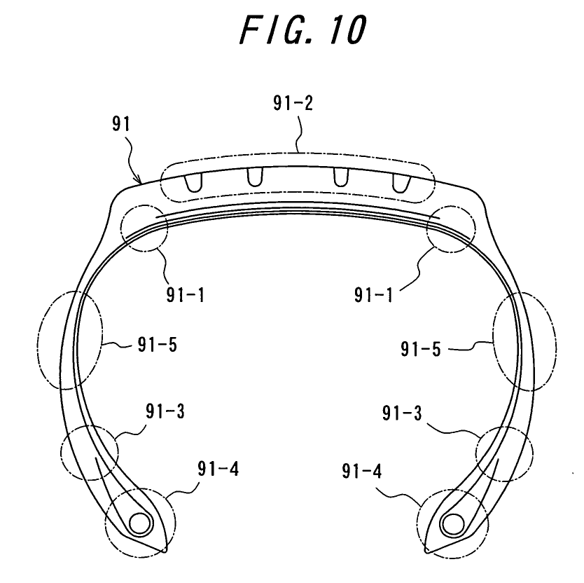

FIG. 10 is a schematic view explaining one example of a tire using the damping alloy member according to the invention. In this example, the damping alloy member 1 having a flake shape with a U-shaped longitudinal cross section shown in FIG. 3a as the damper 21 is embedded in one or more rubber portions such as a shoulder portion 91-1, a tread portion 91-2, a ply-end 91-3, a bead portion 91-4 and a sidewall portion 91-5 of a tire 91, so that the tire 91, which can reduce an impact applied to the tire from a road surface during a moving and can decrease a vibration and a noise, is obtained. Particularly, in the case such that the damping alloy member 1 is embedded in the sidewall portion 91-5, a damping effect due to a generation of a loss in the cornering is expected.

As a shape of the damping alloy member 1 in this example, other than the shapes mentioned above, it is possible to form a gradient structure, in which the intermediate member 31 having an intermediate hardness between the matrix rubber 22 and the damping alloy member 1 is coated to the damper 21 made of the damping alloy member 1 having a flake shape with a U-shaped longitudinal cross section as shown in FIG. 4a, so that a rubber deformation can easily transferred to the damping alloy member 1. Moreover, by utilizing a high thermal conductivity of the damping alloy member 1, an exothermic heat in the tire is transferred to an ambient portion, so that a temperature increasing and inhibiting function can be applied to the tire 91.

<As to the Steel Cord>

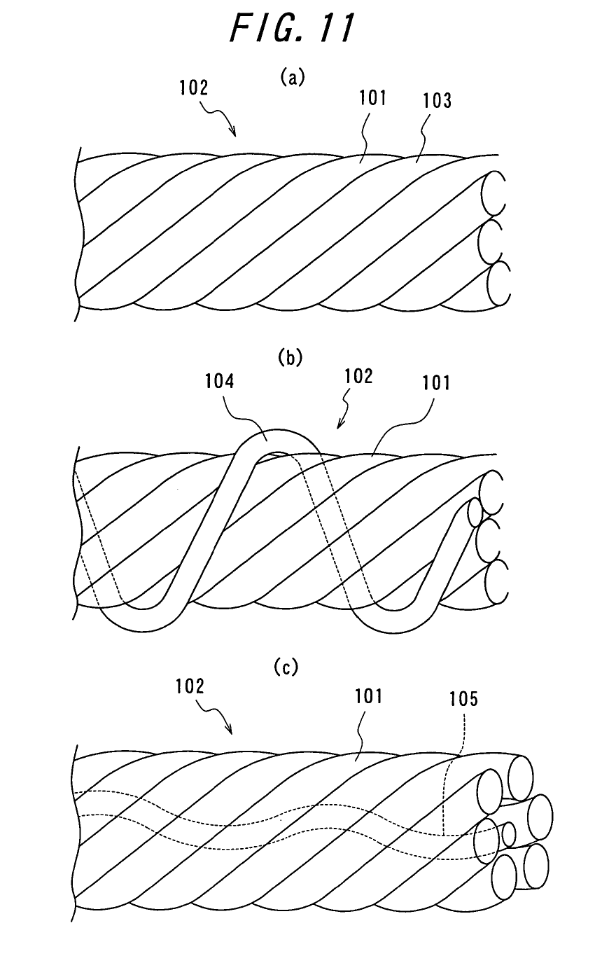

FIGS. 11a-11c are schematic views respectively explaining one example of a steel cord using the damping alloy member according to the invention. In the examples shown in FIGS. 11a-11c, a wire made of the damping alloy member 1 of the twin crystal type is inserted into an inner portion and an outer portion of respective steel wires 101, so that a steel cord 102 is obtained. In the example shown in FIG. 11a, a wire 103 made of the damping alloy member 1 is twisted simultaneously with respective steel wires 101, so that the steel cord 102, in which the wire 103 is arranged at an inner portion, is obtained. On the other hand, in the example shown in FIG. 11b, a wire 104, in which a wire made of the damping alloy member 1 is crimped, is arranged to an outer portion of respective steel wires 101, so that the steel cord 102 is obtained. Further, in the example shown in FIG. 11c, a wire 105, in which the wire made of the damping alloy member 1 is crimped, is arranged at a center portion and respective steel wires 101 is twisted around the crimped steel wire 105, so that the steel cord 102 is obtained.

A tire having the structure such that the steel cord having the construction mentioned above is arranged to an outer layer or the center portion of the tire, or, a tire having the structure such that the steel cord having the construction mentioned above is arranged to one of or both of a breaker portion and a carcass portion of the tire, can reduce a vibration and a noise by means of the damping alloy member 1 according to the invention, when the steel cord 102 is deformed by an impact applied to the tire from a road surface during the moving.

<As to the Quake-Absorbing Rubber>

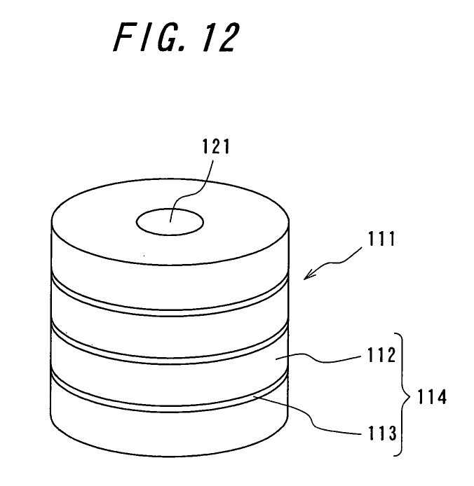

FIG. 12 is a schematic view showing one embodiment of a first aspect of a quake-absorbing rubber using the damping alloy member according to the invention. In the example shown in FIG. 12, a quake-absorbing rubber 111 comprises a laminated rubber 114 having an integral structure obtained by laminating alternately a high damping rubber sheet 112 and a metal plate 113 and a damper member 121 arranged at a center portion of the laminated rubber 114. Here, the laminated rubber 114 has the same structure as that of the conventional laminated rubber.

Features of the quake-absorbing rubber 11 of the invention are that the damper member 121 is combined with the laminated rubber 114 and that a structure of the damper member 121 specifically such that the damper member 121 is constructed by compounding the damper made of the damping alloy member 1 of the twin crystal type and the normal rubber. Hereinafter, the quake-absorbing rubber 111 according to the invention will be explained in further detail.

In the quake-absorbing rubber 11 according to the invention, as the damping alloy member 1 of the twin crystal type consisting of the damper included in the damper member 121, any materials known as the damping alloys of the twin crystal type can be used as mentioned above. Particularly, it is preferred to use Cu—Al—Mn alloy, Mg—Zr alloy, Mn—Cu alloy, Mn—Cu—Ni—Fe alloy, Cu—Al—Ni alloy, Ti—Ni alloy, Al—Zn alloy, Cu—Zn—Al alloy, or Mg alloy, and it is most preferred to use Cu—Al—Mn alloy. In this case, the reason for using the damping alloy of a twin crystal type is as follows. That is to say, a martensite twin crystal structure according to this embodiment is easily deformed by an external input, and, at that time, an energy loss due to hysteresis is generated. This is because the martensite twin crystal is not broken by fatigue, since it is not a material, in which a dislocation is not generated by a plastic deformation, and only a positional relation of atoms are changed.

Moreover, in the quake-absorbing rubber 111 according to the invention, as a shape of the damper included in the main member 121, it is preferred to use a flake shape, since a shape of the damping alloy can be optimized. Here, the reason for preferably using the flake shape is that a damping effect of the damper can be easily obtained.

Further, in the quake-absorbing rubber 111 according to the invention, as a material of rubber consisting of a main construction member of the damper member 121, it is possible to use any rubber used for the conventional rubber vibration isolators. Specifically, as one example, it is preferred to use a natural rubber, a styrene rubber, a nitrile rubber, a chloroprene rubber and a butyl rubber.

Furthermore, in the quake-absorbing rubber 111 according to the invention, a compounding rate between the damper and the rubber is not particularly limited. The compounding rate can be determined suitably so as to obtain most suitable damping properties as the quake-absorbing rubber 111 having the damper member 121 in which the damper and the rubber are compounded. Normally, it is preferred to set the compounding rate such as damper: 1-50 vol % and rubber: remainder. Here, if an amount of the damper is less than 1 vol %, a contribution rate of the alloy is small. On the other hand, if an amount of the damper exceeds 50 vol %, a mixing resistance during the manufacturing becomes too large and thus the manufacturing is not to be possible.

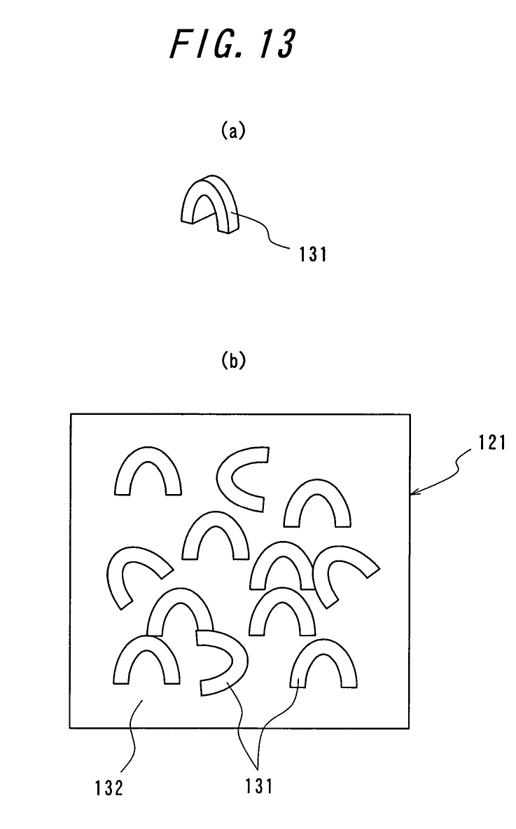

FIGS. 13a and 13b are schematic views respectively explaining one example of a damper member of the first aspect of the quake-absorbing rubber using the damping alloy member according to the invention. In this example, use is made of a damper 131 made of the twin crystal type damping alloy member 1 and having a flake shape with a U-shaped longitudinal cross section as shown in FIG. 13a. A plurality of dampers 131 are randomly mixed and compounded in a rubber 132, so that the damper member 121 is constructed as shown in FIG. 13b. In this example, since, in addition to a damping performance based on an elastic deformation of the rubber 132, a damping performance based on a deformation of twin crystal of the damper 131 made of the damping alloy member 1 of the twin crystal type, it is possible to obtain a high damping performance as compared with the quake-absorbing rubber made of the conventional laminated rubber only.

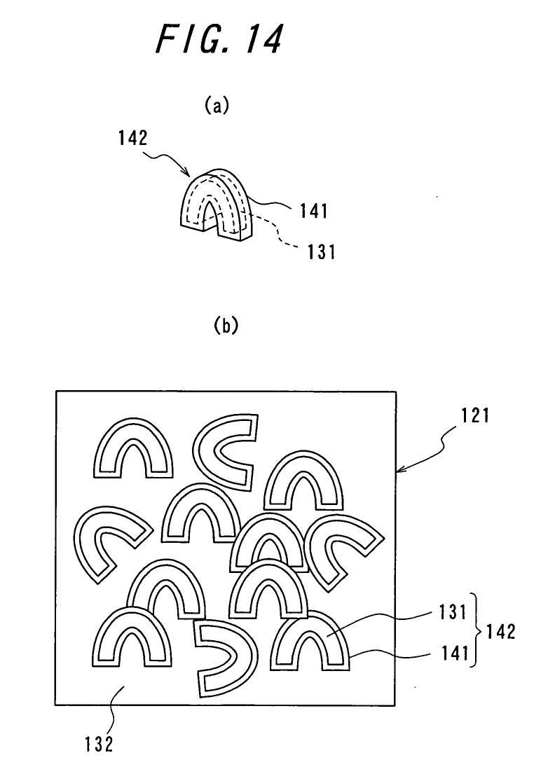

FIGS. 14a and 14b are schematic views respectively explaining one example of a damper member of the first aspect of the quake-absorbing rubber using the damping alloy member according to the invention. In this example, use is made of a damper 142 having a structure such that an intermediate layer 141 made of a material having an intermediate deformation stress (Young's modulus, strength) between a damping property of the damper 131 and a damping property of the rubber 132 is arranged to an overall outer surface of the damper 131 made of the twin crystal type damping alloy member 1 having a flake shape with a U-shaped longitudinal cross section as shown in FIG. 14a. As a material having an intermediate damping property between a damping property of the damper 131 and a damping property of the rubber 132, consisting of the intermediate layer 141, use is made of polyamide, polyacetal, polycarbonate, polyphenylene ether, polybutadiene terephthalate, polyphenylene sulfide, amorphous polymer and so on. A plurality of dampers 142 are randomly mixed and compounded in the rubber 132, so that the damper member 121 is constructed as shown in FIG. 14b. In this example, since, in addition to an effect of obtaining a high damping performance based on the damper member 121 shown in FIGS. 14a and 14b, the intermediate layer 141 carries out a function as a gradient material, it is possible to obtain a higher damping performance as that of the example shown in FIGS. 14a and 14b.

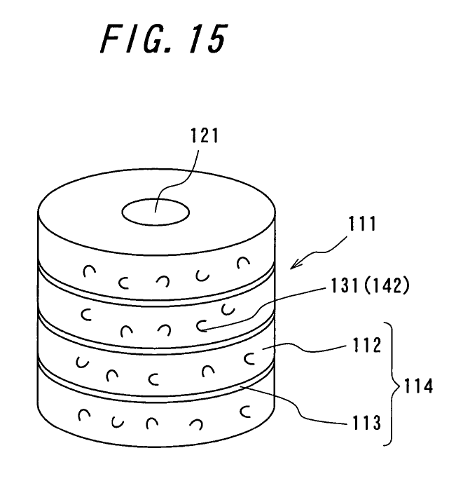

FIG. 15 is a schematic showing another embodiment of the first aspect of the quake-absorbing rubber using the damping alloy member according to the invention. In the example shown in FIG. 15, the damper member 121 is arranged at a center portion of the laminated rubber 114, and the dampers 131(142) are mixed in the high damping rubber sheet 112 of the laminated rubber 114. In this example, an effect of the dampers 131(142) can be remarkably improved.

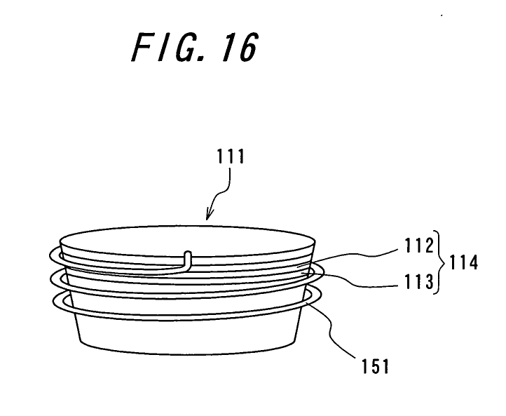

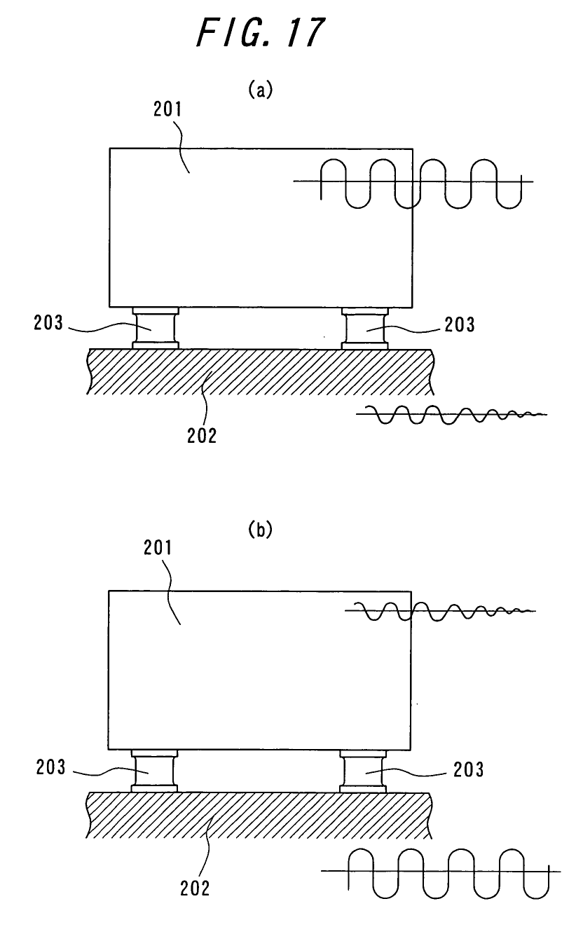

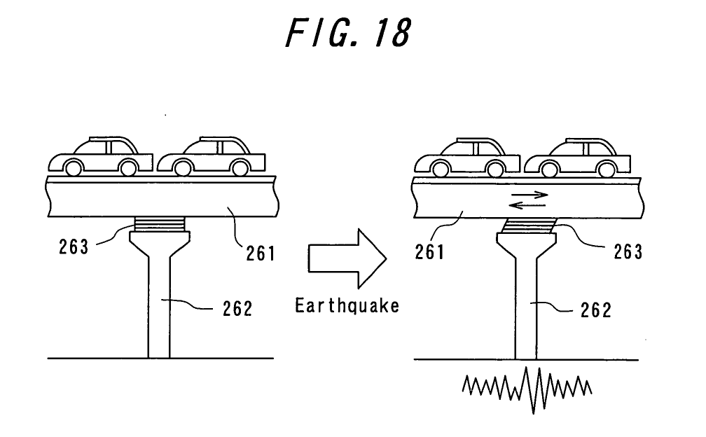

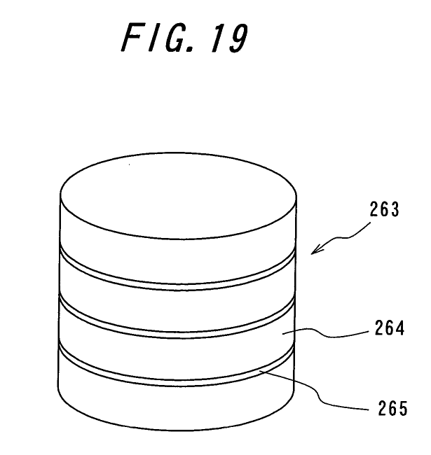

FIG. 16 is a schematic view showing one embodiment of a second aspect of the quake-absorbing rubber using the damping alloy member according to the invention. In the example shown in FIG. 16, the quake-absorbing rubber 111 is constructed in such a manner that a damper 151 having a spring shape made of the damping alloy member 1 of the twin crystal type is wound around an outer portion of the laminated rubber 114 having an integral structure obtained by laminat-ing alternately the high damping rubber sheet 112 and the metal plate 113, and, the laminated rubber 114 and the damper 151 are combined with each other. In the preferred example of this embodiment, a periphery of the damper 151 having a spring shape is covered with an elastic member such as rubber and so on, so that the damper 151 having a spring shape can be protected. Moreover, as the damping alloy member 1 of the twin crystal type consisting of the damper 151, use is made of the same materials as those of the damping alloy member 1 of the twin crystal type consisting of the damper in the quake-absorbing rubber 111 according to the first aspect mentioned above.

The quake-absorbing rubber 111 according to the second aspect having the construction mentioned above can be manufactured by producing preliminarily the laminated rubber 114 and winding the damper 151 having a spring shape and made of the damping alloy member 1 of the twin crystal type around the laminated rubber. Moreover, the quake-absorbing rubber 111 according to the second aspect having the construction mentioned above can be also manufactured by producing preliminarily the laminated rubber 114 using a non-cured rubber, winding the damper 151 having a spring shape and made of the damping alloy of the twin crystal type around the laminated rubber 114 and curing it finally.

### INDUSTRIALLY APPLICABILITY

The damping alloy member according to the invention can reduce a vibration and a noise from a viewpoint of the shape, in addition to a damping property of the alloy, and thus it is preferably used for: the damping alloy member having a function of reducing a high vibration and a noise; and the rubber damping isolator, the floor vibration damping apparatus, the tire and the steel cord, which utilize the damping alloy member. Moreover, the quake-absorbing rubber made of the damping alloy member according to the invention can absorb an energy during earthquake as is the same as the conventional quake-absorbing rubber, and thus it is preferably used for the construction members of the quake-absorbing apparatus for architecture/bridge construction, which further requires a rapid ceasing of the vibration during earthquake.

1. A damping alloy member characterized in that the improvement consists of a twin crystal type damping alloy made of Cu—Al—Mn alloy, Mg—Zr alloy, Mn—Cu alloy, Mn—Cu—Ni—Fe alloy, Cu—Al—Ni alloy, Ti—Ni alloy, Al—Zn alloy, Cu—Zn—Al alloy, Mg alloy, Cu—Si alloy, Fe—Mn—Si alloy, Fe—Ni—Co—Ti alloy, Fe—Ni—C alloy, Fe—Cr—Ni—Mn—Si—Co alloy and Ni—Al alloy, and has a shape of a flake, a wire or a spring for optimizing a deformation of the alloy.

2. A rubber vibration isolator characterized in that a rubber and a damper made of the damping alloy member set forth in claim 1 are compounded.

3. The rubber vibration isolator according to claim 2, wherein a most elastically deformed direction of the damper is made to be same as a deformation direction of the rubber vibration isolator.

4. A floor vibration damping apparatus characterized in that the improvement consists of a composite material in which a rubber and the damping alloy member set forth in claim 1 are compounded.

5. The floor vibration damping apparatus according to claim 4, wherein the damping alloy member has a spring structure such that a plurality of springs, having different spring constants in a height direction, are combined and used in such a manner that: a vibration under a low loading state is absorbed by a spring having a low spring constant; and a vibration under a high loading state is absorbed by a spring having a high spring constant, while the spring having a low spring constant is contacted to a cap.

6. A tire characterized in that the damping alloy member set forth in claim 1 is embedded in the tire so as to reduce an impact applied to a moving tire from a road surface and to decrease a vibration and a noise.

7. The tire according to claim 6, wherein the damping alloy member having a flake shape is used.

8. A steel cord characterized in that the improvement has a structure such that the damping alloy member set forth in claim 1 is inserted into an inner portion and an outer portion of the steel cord.

9. The steel cord according to claim 8, wherein the damping alloy member having a wire shape or a crimped wire shape is used, so that a deformation of the steel cord is easily transferred to the damping alloy member.

10. A tire consisting of the steel cord set forth in claim 8, characterized in that, in the case such that the steel cord is deformed by an impact applied to a moving tire from a road surface, the improvement has a function such that a vibration and a noise are reduced by the damping alloy member.

11. A quake-absorbing rubber characterized in that a damper member, in which a rubber and a damper made of the damping alloy member set forth in claim 1 are compounded, is combined with a laminated rubber having an integral structure obtained by laminating alternately a high damping rubber sheet and a metal plate.

12. The quake-absorbing rubber according to claim 11, wherein the damper member is arranged at a center portion of the laminated rubber.

13. The quake-absorbing rubber according to claim 11, wherein the damper has a flake shape.

14. The quake-absorbing rubber according to claim 11, wherein the damper is mixed in the high damping rubber sheet of the laminated rubber.

15. The quake-absorbing rubber according to claim 11, wherein use is made of the damper having a structure such that an intermediate layer made of a material having an intermediate deformation stress (Young's modulus, strength) between a damping property of the damper and a damping property of the rubber is arranged to an overall outer surface of the damper.

16. A quake-absorbing rubber characterized in that a damper having a spring shape made of the damping alloy member set forth in claim 1 is wound around an outer portion of a laminated rubber having an integral structure obtained by laminating alternately a high damping rubber sheet and a metal plate, and the laminated rubber and the damper are combined with each other.

17. The quake-absorbing rubber according to claim 16, wherein a periphery of the damper having a spring shape is covered with an elastic member.
